(19) United States
(12) Patent Application Publication
(10) Pub. No.: US 2024/0424722 A1
(43) Pub. Date: Dec. 26, 2024

(54) ASSEMBLY METHOD AND STRUCTURE OF CONTROL DEVICE

(71) Applicant: TING-JUI WANG, New Taipei City (TW)

(72) Inventor: TING-JUI WANG, New Taipei City (TW)

(21) Appl. No.: 18/829,326

(22) Filed: Sep. 10, 2024

Related U.S. Application Data
(62) Division of application No. 16/817,560, filed on Mar. 12, 2020.

(30) Foreign Application Priority Data
Mar. 15, 2019 (TW) 108108977

(51) Int. Cl. B29C 45/26; B29C 45/14; B29C 45/76; F16B 21/00

(52) U.S. Cl. CPC B29C 45/2602; B29C 45/14008; B29C 45/76; F16B 21/00

(57) ABSTRACT

An assembly method and a structure of a control device are introduced. The control device includes a head and a body. The head includes a stopping portion, and the body includes a corresponding stopping portion. The head is movably assembled with the body upon pressurizing the head or the body by an external force. Thus, the head and the body can be quickly assembled into a control device, while achieving effects of easy assembly and better stability after the assembly.

### CROSS-REFERENCE TO RELATED APPLICATION

This application is a divisional patent application of U.S. application Ser. No. 16/817,560 filed on Mar. 12, 2020, the entire contents of which are hereby incorporated by reference for which priority is claimed under 35 U.S.C. § 121.

### BACKGROUND OF THE INVENTION

### 1. Field of the Invention

The present invention relates to an assembly method and a structure of a control device and, more particularly, to an assembly method and a structure of a control device capable of quickly assembling into a control device, while achieving effects of easy assembly and better stability after the assembly.

### 2. Description of the Related Art

A control device engagingly connected with at least one object usually demands more man-hours and work processes for assembly and manufacturing due to a smaller volume and higher precision, resulting in issues that assembly cannot be performed quickly.

Therefore, it is an object of the present invention to disclose an assembly method and a structure of a control device capable of quickly assembling into a control device, while achieving effects of easy assembly and better stability after the assembly.

### BRIEF SUMMARY OF THE INVENTION

In view of the issues and drawbacks of the prior art described above, the Inventor has dedicated to improvement and research in the aim of developing an assembly method and a structure of a control device, so as to quickly assembling into a control device, while achieving objects of easy assembly and better stability after the assembly.

To achieve the foregoing object and other objects, the present invention provides an assembly method of a control device. The control device includes a head and a body. The head includes a stopping portion, and the body includes a corresponding stopping portion. The head is movably assembled with the body upon pressurizing the head or the body by an external force.

In the assembly method of a control device above, the stopping portion is pressurized by a mold to form the stopping portion deformed inward on another mold, so as to stop and limit the outwardly protruding corresponding stopping portion of the body.

In the assembly method of a control device above, the body can first be placed at a placement mold, the another mold then laterally enters a formation region, and the head is then pressurized by the mold to allow the stopping portion to form the stopping portion deformed inward on the another mold, so as to stop and limit the outwardly protruding corresponding stopping portion of the body.

In the assembly method of a control device above, the head is pressurized by a mold such that the corresponding stopping portion of the body provided on another mold is pressed by the head to form by deformation the corresponding stopping portion deformed inward, so as to stop and limit the stopping portion of the head.

In the assembly method of a control device above, the head is pressurized by a mold such that the elastic stopping portion protruding inward is abutted against the corresponding stopping portion of the body provided on another mold, so as to elastically engage and assemble the pressed and expanded stopping portion with the corresponding stopping portion protruding outward.

In the assembly method of a control device above, the stopping portion or the corresponding stopping portion has a guiding surface for guiding forming assembly or elastic engaging assembly.

In the assembly method of a control device above, the guiding surface is an inclined surface, an arc surface, a curved surface, a stepped portion, a planar portion, a recess, a protrusion, a groove or a hole.

In the assembly method of a control device above, the head consists of a setting-up element and a set-up element.

In the assembly method of a control device above, the setting-up element includes a rivet portion for being pressurized by a mold so as to rivet the rivet portion to the set-up element on another mold.

In the assembly method of a control device above, the setting-up element is for in-mold injecting the set-up element at the setting-up element by in-mold injection in a mold.

In the assembly method of a control device above, the set-up element is for in-mold injecting an external forming element at the set-up element by in-mold injection in a mold.

In the assembly method of a control device above, the head is injection molded in a mold by in-mold injection.

In the assembly method of a control device above, the set-up element passes through the body and is riveted to the setting-up element.

In the assembly method of a control device above, the setting-up element includes an expansion connection portion for being pressurized by a mold to expandingly connect the expansion connection portion to the set-up element.

In the assembly method of a control device above, the setting-up element passes through the body and is expandingly connected to the set-up element.

In the assembly method of a control device above, each of the head, the setting-up element and the set-up element includes an engaging portion.

In the assembly method of a control device above, the engaging portion is a threaded body, an outer engaging body, an elastic engaging body, an inner engaging body or a rod.

In the assembly method of a control device above, the engaging portion is the stopping portion or the corresponding stopping portion.

In the assembly method of a control device above, the setting-up element and the set-up element are a pressure elastic engaging assembly, a rivet connection assembly, an expansion connection assembly, a lock connection assembly, a solder connection assembly or a penetration connection assembly.

In the assembly method of a control device above, the hardness of the stopping portion or the corresponding stopping portion deformed during the assembly process is less than, equal to or more than that of the another mold.

In the assembly method of a control device above, the hardness of the mold during the assembly process is more than, equal to or less than the hardness of an object being pressurized by the mold.

In the assembly method of a control device above, the head or the body is made of a metal material, a non-metal material or a plastic material.

In the assembly method of a control device above, the in-mold injection process is a plastic in-mold injection process.

In the assembly method of a control device above, an elastic element is further included. One end of the elastic element is abutted against the head and the other end of the elastic element is abutted against the body.

In the assembly method of a control device above, the body includes a coupling portion for rivet connecting, solder connecting, expansion connecting, lock connecting, elastic engagement connecting or engagement connecting to an object or forming an integral with an object.

In the assembly method of a control device above, the setting-up element or the set-up element is pressurized and penetratingly connected by a penetration connector so as to be movably assembled with the body.

In the assembly method of a control device above, the setting-up element and the set-up element is penetratingly connected by a penetration connector, and is expandingly connected by a mold so as to be movably assembled with the body.

In the assembly method of a control device above, the head passes through the body and the head is pressurized by a mold to deform the stopping portion that then protrudes outward, so as to be movably assembled with the body.

In the assembly method of a control device above, abutment of the elastic force of the elastic element is interference abutment with a minimized distance or a spatial abutment with a maximized space between the stopping portion and the corresponding stopping portion.

In the assembly method of a control device above, the head or the body is manufactured and formed by lathe manufacturing, forging, rolling, injection manufacturing, stamping, in-mold injection or milling machine manufacturing methods.

In the assembly method of a control device above, the head or the body includes an engaging portion, and the engaging portion is a threaded body, an outer engaging body, an elastic engaging body, an inner engaging body or a rod.

In the assembly method of a control device above, the body is placed at a placement mold, another mold laterally enters a formation region, and the head is pressurized by a mold to form the stopping portion at the another mold, so as to stop and limit the corresponding stopping portion of the body.

In the assembly method of a control device above, the body is placed at a placement mold, the another mold laterally enters a formation region, and the head is pressurized by the mold to allow the stopping portion to form the stopping portion deformed inward at the another mold, so as to stop and limit the outwardly protruding corresponding stopping portion of the body.

In the assembly method of a control device above, the head or the body is pressurized by a mold to press the corresponding stopping portion of the body provided on another mold and to form by deformation the corresponding stopping portion, so as to stop and limit the stopping portion.

In the assembly method of a control device above, the head or the body is placed at a placement mold, another mold laterally enters a formation region, and the head or the body is pressurized by a mold to form the stopping portion at the another mold, so as to stop and limit the corresponding stopping portion.

In the assembly method of a control device above, the setting-up element and the set-up element are penetratingly connected by a penetration connector so as to be movably assembled with the body, wherein the penetration connector has an elastic engagement space and presses the elastic engagement space for elastic abutment and assembly during the pressurizing and penetration connection.

In the assembly method of a control device above, the head consists of a setting-up element and a set-up element, wherein the set-up element is the body.

In the assembly method of a control device above, the head is a setting-up element, and the body is a set-up element.

In the assembly method of a control device above, the setting-up element and the set-up element are penetratingly connected and assembled by a penetration connector, wherein the penetration connector has an elastic engagement space and presses the elastic engagement space for elastic abutment and assembly during the pressurizing and penetration connection.

In the assembly method of a control device above, the setting-up element or the set-up element is penetratingly connected by a penetration connector and is then expandingly connected by a mold so as to be movably assembled.

In the assembly method of a control device above, the penetration connector has a guiding entering portion, the guiding entering portion is for guiding and penetration connection, and the guiding entering portion is an arc surface, a curved surface, an inclined surface or a stepped surface.

The present invention further provides a structure of a control device which is made by the assembly method of a control device described above.

Accordingly, the assembly method and structure of a control device of the present invention are capable of quickly assembling the head and the body into a control device, and achieving objects of easy assembly and better stability after the assembly.

### BRIEF DESCRIPTION OF THE DRAWINGS

FIG. 1 is a schematic diagram of an unassembled state according to a first embodiment of the present invention.

FIG. 2 is a schematic diagram of a state of assembly according to the first embodiment of the present invention.

FIG. 3 is a schematic diagram of completion of assembly according to the first embodiment of the present invention.

FIG. 4 is a schematic diagram of different forms of an engaging portion of the present invention.

FIG. 5 is a schematic diagram of an unassembled state according to a second embodiment of the present invention.

FIG. 6 is a schematic diagram of a state of assembly according to the second embodiment of the present invention.

FIG. 7 is a schematic diagram of a state of assembly according to a third embodiment of the present invention.

FIG. 8 is a schematic diagram of a state of assembly according to a fourth embodiment of the present invention.

FIG. 9 is a schematic diagram of a state of assembly according to a fifth embodiment of the present invention.

FIG. 10 is a schematic diagram of a state of assembly according to a sixth embodiment of the present invention.

FIG. 11 is a schematic diagram of a state of assembly according to a seventh embodiment of the present invention.

FIG. 12 is a schematic diagram of a state of assembly according to an eighth embodiment of the present invention.

FIG. 13 is a schematic diagram of a state of assembly according to a ninth embodiment of the present invention.

FIG. 14 is a schematic diagram of a state of assembly according to a tenth embodiment of the present invention.

FIG. 15 is a schematic diagram of a state of assembly according to an eleventh embodiment of the present invention.

FIG. 16 is a schematic diagram of a state of assembly according to a twelfth embodiment of the present invention.

FIG. 17 is a schematic diagram of a state of assembly according to a thirteenth embodiment of the present invention.

FIG. 18 is a schematic diagram of a state of assembly according to a fourteenth embodiment of the present invention.

FIG. 19 is a schematic diagram of a state of assembly according to a fifteenth embodiment of the present invention.

FIG. 20 is a schematic diagram of a state of assembly according to a sixteenth embodiment of the present invention.

FIG. 21 is a schematic diagram of a state of assembly according to a seventeenth embodiment of the present invention.

FIG. 22 is a schematic diagram of a state of assembly according to an eighteenth embodiment of the present invention.

FIG. 23 is a schematic diagram of a state of a cross section according to a nineteenth embodiment of the present invention.

FIG. 24 is a schematic diagram of a state of a cross section according to a twentieth embodiment of the present invention.

FIG. 25 is a schematic diagram of a state of assembly according to a twenty-first embodiment of the present invention.

FIG. 26 is a schematic diagram of a state of a cross section according to a twenty-second embodiment of the present invention.

FIG. 27 is a first schematic diagram of a state of assembly according to a twenty-third embodiment of the present invention.

FIG. 28 is a second schematic diagram of a state of assembly according to the twenty-third embodiment of the present invention.

### DETAILED DESCRIPTION OF THE INVENTION

To fully understand the objects, features and effects of the present invention, details of the present invention are described with the accompanying drawings in the specific embodiments below.

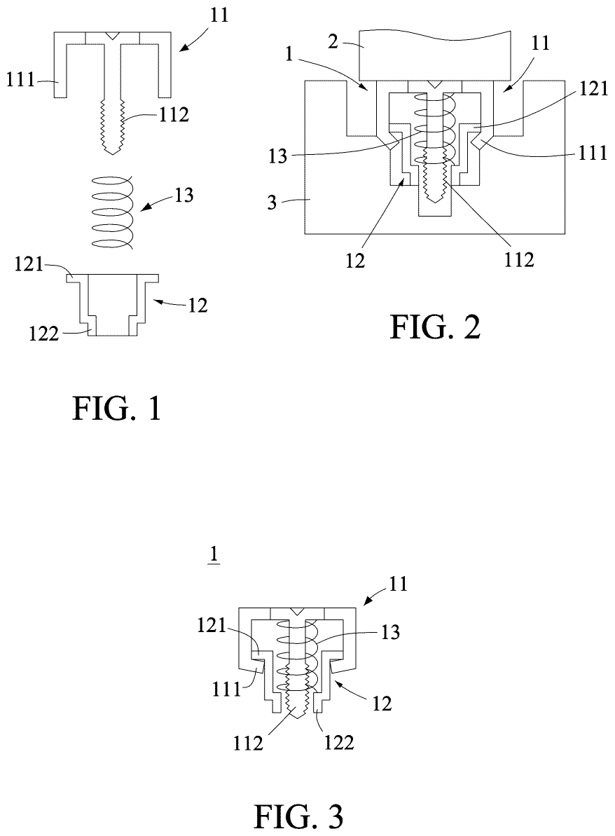

Referring to FIG. 1 to FIG. 3, as shown in the drawings, the present invention provides an assembly method and a structure of a control device 1. In the assembly method of the control device 1, the control device 1 includes a head 11 and a body 12. The head 11 includes a stopping portion 111, and the body 12 includes a corresponding stopping portion 121. The head 11 and the body 12 are movably assembled by pressure of an external force applied on the head 11 or the body 12, thereby assembling into the structure of a control device.

For assembly, the assembly operation can be performed in conjunction with a mold 2 and another mold 3. To start the assembly process, the head 12 is first placed at the another mold 3, and the head 11 is pressurized by the mold 2 such that the stopping portion 111 is pressurized by the mold 2 to form the stopping portion 111 deformed inward on the another mold 3, so as to stop and limit the outwardly protruding corresponding stopping portion 121 of the body 12, thereby quickly assembling into a control device 1 and achieving the objects of easy assembly and better stability after the assembly.

Furthermore, before the head 11 and the body 12 are assembled, an elastic element 13 can be further placed between the head 11 and the body 12. When the head 11 and the body 12 are assembled, one end of the elastic element 13 is abutted against the head 11 and the other end of the elastic element 13 is abutted against the body 12, enabling the present invention to respond to requirements of different utilization conditions.

In a preferred embodiment of the present invention, the head 11 includes an engaging portion 112. The engaging portion 112 can be a threaded body, and the control device 1 can be engagingly connected to an object (not shown) required by using the engaging portion 112.

In a preferred embodiment of the present invention, during the assembly process, the hardness of the deformed stopping portion 111 (or the corresponding stopping portion 121) is less than, equal to or more than that of the another mold 3; during the assembly process, the hardness of the mold 2 is more than, equal to or less than that of an object (e.g., the head 11 and the stopping portion 111) pressurized by the mold 2, enabling the present invention to respond to requirements of actual assembly conditions.

In a preferred embodiment of the present invention, the head 11 or the body 12 is made of a metal material, a non-metal material or a plastic material, enabling the present invention to respond to requirements of different utilization conditions.

In a preferred embodiment of the present invention, the body 12 includes a coupling portion 122 for rivet connecting, solder connecting, expansion connecting, lock connecting, elastic engagement connecting or engagement connecting to an object or to form an integral with the object, and to engagingly connect to another object (not shown) by the engaging portion 112, enabling the present invention to respond to requirements of different utilization conditions.

In a preferred embodiment of the present invention, the head 11 or the body 12 is manufactured and formed by lathe manufacturing, forging, rolling, injection manufacturing, stamping, in-mold injection or milling machine manufacturing methods, enabling the present invention to respond to requirements of different utilization conditions.

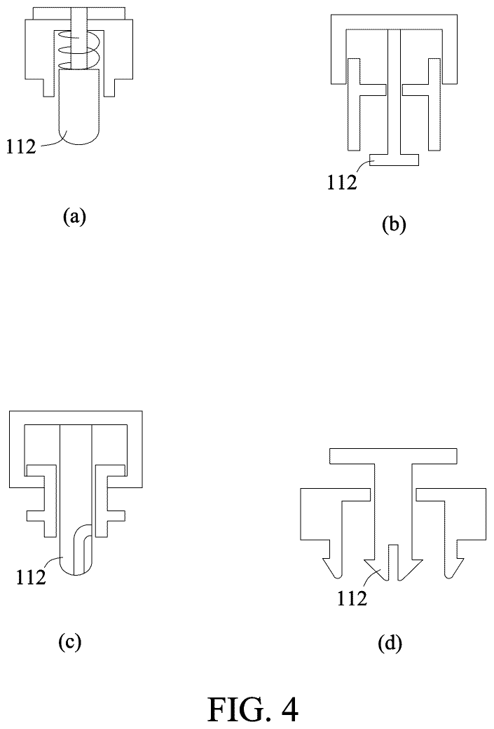

Referring to FIG. 4, as shown in the drawing, in a preferred embodiment of the present invention, the engaging portion 112 can be a rod (as part a in FIG. 4), an outer engaging body (as part b in FIG. 4), an inner engaging body (as part c in FIG. 4) or an elastic engaging body (as part d in FIG. 4), enabling the present invention to respond to requirements of different utilization conditions.

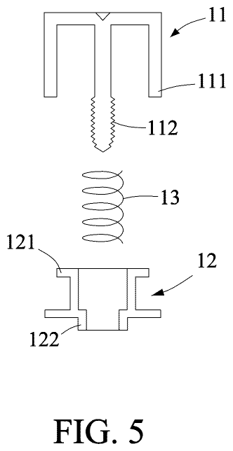

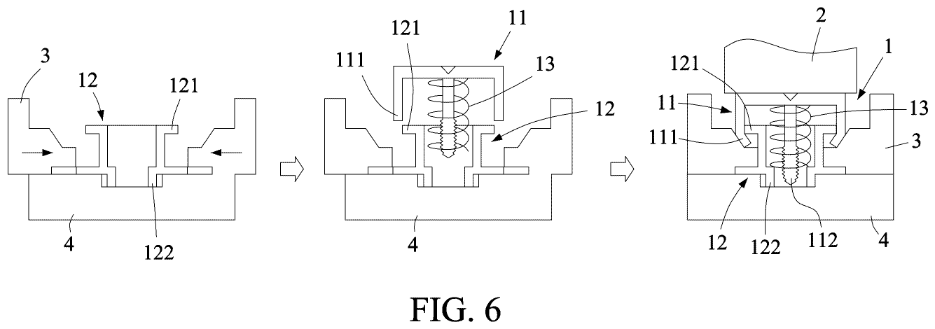

Referring to FIG. 5 and FIG. 6, as shown in the drawings, in a preferred embodiment of the present invention, the body 12 can be first placed at a placement mold 4, the another mold 3 laterally enters a formation region, and then the head 11 is pressurized by the mold 2 to allow the stopping portion 111 to form the stopping portion 111 deformed inward at the another mold 3, so as to stop and limit the outwardly protruding corresponding stopping portion 121 of the body 12, thereby quickly assembling into a control device 1 and achieving objects of easy assembly and better stability after the assembly.

The body 12 can also be placed at the placement mold 4, and the another mold 3 laterally enters the formation region, and the head 11 is pressurized by the mold 2 to form the stopping portion 111 at the another mold 3, so as to stop and limit the corresponding stopping portion 121 of the body 12.

Furthermore, the head 11 or the body 12 can be placed at the placement mold 4, the another mold 3 laterally enters the formation region, and the head 11 or the body 12 is pressurized by the mold 2 to form the stopping portion 111 at the another mold 3, so as to stop and limit the corresponding stopping portion 121.

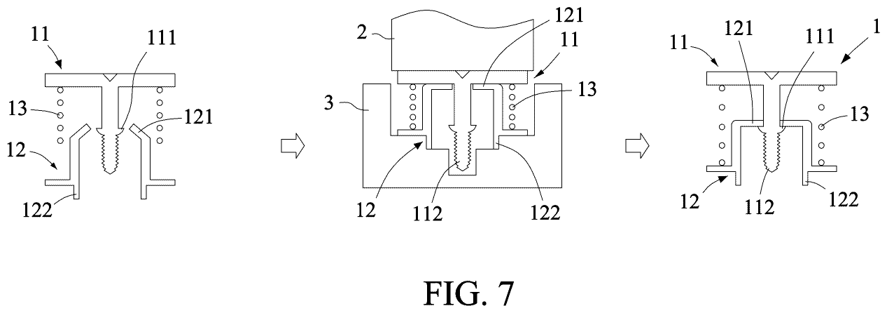

Referring to FIG. 7, as shown in the drawing, in a preferred embodiment of the present invention, the head 11 is pressurized by a mold 2 to press the corresponding stopping portion 121 of the body 12 provided on another mold 3 by the head 11 and to form by deformation the corresponding stopping portion 121 deformed inward, so as to stop and limit the stopping portion 111 of the head 11, thereby quickly assembling into a control device 1 and achieving objects of easy assembly and better stability after the assembly.

Furthermore, the head 11 (or the body 12) is pressurized by the mold 2 to press the corresponding stopping portion 121 of the body 12 provided on the another mold 3 and to form by deformation the corresponding stopping portion 121, so as to stop and limit the stopping portion 111.

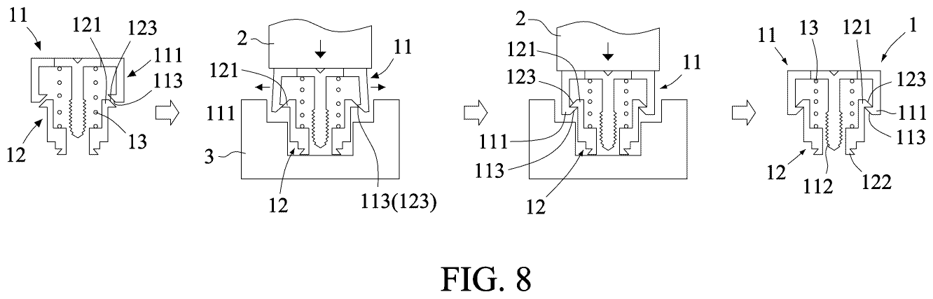

Referring to FIG. 8, as shown in the drawing, in a preferred embodiment of the present invention, the head 11 is pressurized by a mold 2 to abut the elastic stopping portion 111 protruding inward against the corresponding stopping portion 121 of the body 12 provided on another mold 3, so as to allow the pressed and expanded stopping portion 111 to be elastically engaged and assembled with the corresponding stopping portion 121 protruding outward. The stopping portion 111 or the corresponding stopping portion 121 has respective guiding surfaces 113 and 123 for guiding forming assembly or elastic engagement assembly. Each of the guiding surfaces 113 and 123 can be an inclined surface, an arc surface, a curved surface, a stepped portion, a planar portion, a recess, a protrusion, a groove or a hole, thereby quickly assembling into a control device 1 and achieving objects of easy assembly and better stability after the assembly.

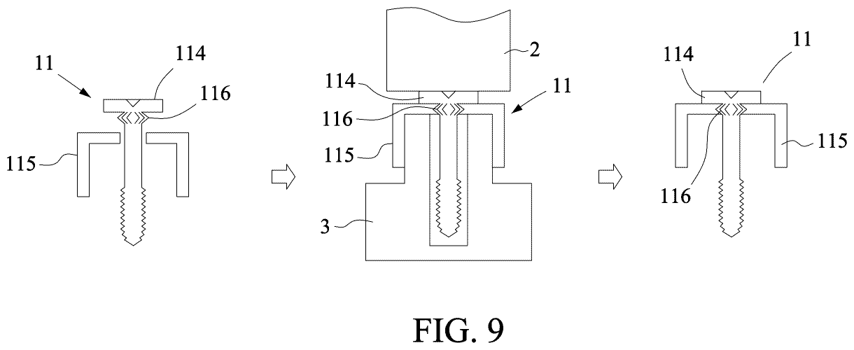

Referring to FIG. 9, as shown in the drawing, in a preferred embodiment of the present invention, the head 11 consists of a setting-up element 114 and a set-up element 115., wherein the set-up element 115 is the body, and the setting-up element 114 includes a rivet portion 116. The setting-up element 114 is pressurized by a mold 2 to rivet the rivet portion 116 to the set-up element 115 on another mold 3, enabling the head 11 to respond to requirements of different utilization conditions.

Furthermore, the setting-up element 114 and the set-up element 115 can be a pressure elastic engaging assembly, a rivet connection assembly, an expansion connection assembly, a lock connection assembly, a solder connection assembly or a penetration connection assembly, enabling the head 11 to respond to requirements of different utilization conditions.

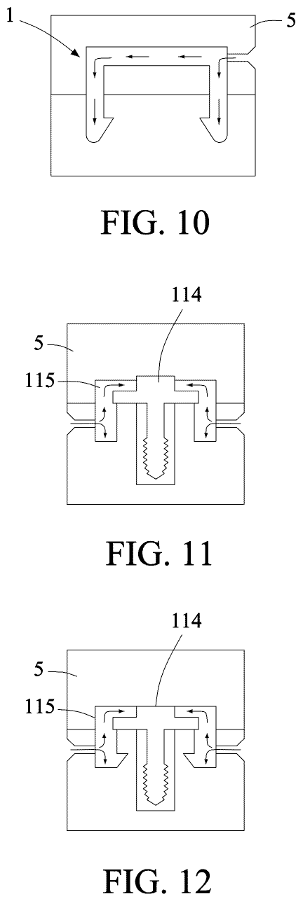

Referring to FIG. 10, as shown in the drawing, in a preferred embodiment of the present invention, the head 11 is injected and formed by in-mold injection in a mold 5, enabling the head 11 to respond to requirements of different utilization conditions.

Referring to FIG. 11 and FIG. 12, as shown in the drawings, in a preferred embodiment of the present invention, the setting-up element 114 is used for in-mold injecting the set-up element 115 at the setting-up element 114 by in-mold injection in a mold 5, so as to respond to requirements of different utilization conditions.

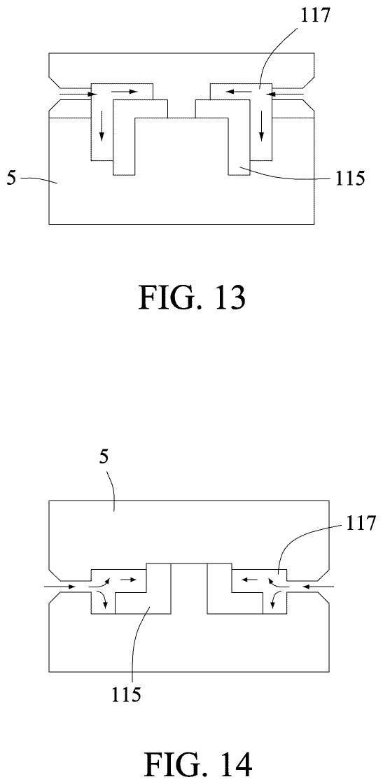

Referring to FIG. 13 and FIG. 14, as shown in the drawings, in a preferred embodiment of the present invention, the set-up element 115 is used for forming an external forming element 117 at the set-up element 115 by in-mold injection in a mold 5, wherein the process of the in-mold injection is a plastic in-mold injection process, so as to respond to requirements of different utilization conditions.

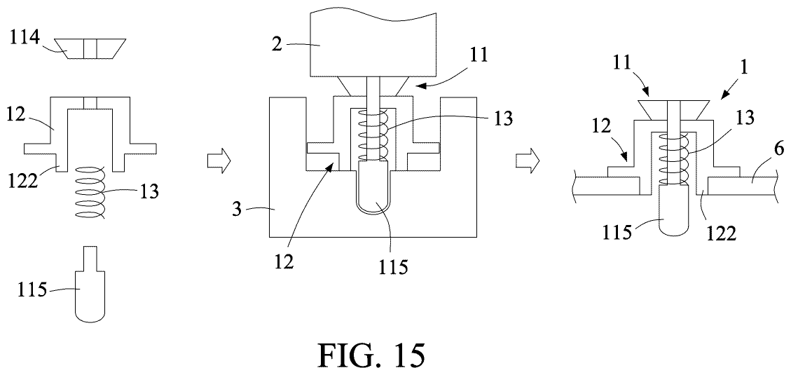

Referring to FIG. 15, as shown in the drawing, in a preferred embodiment of the present invention, the set-up element 115 passes through the body 12 and is placed on another mold 3, and the mold 2 is riveted to the setting-up element 114 to further assemble the head 11 with the body 12, thereby quickly assembling into a control device 1 and achieving objects of easy assembly and better stability after the assembly. Furthermore, the coupling portion 122 of the body 12 can be assembled with an object 6, so as to respond to requirements of different utilization conditions.

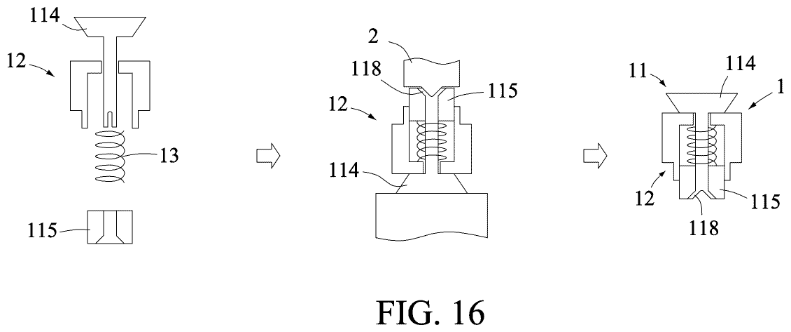

Referring to FIG. 16, as shown in the drawing, in a preferred embodiment of the present invention, the setting-up element 114 includes an expansion connection portion 118. The setting-up element 114 passes through the body 12 and is pressurized by a mold 2 to expandingly connect the expansion connection portion 118 to the set-up element 115 so as to assemble the head 11 with the body 12, thereby quickly assembling into a control device 1 and achieving objects of easy assembly and better stability after the assembly.

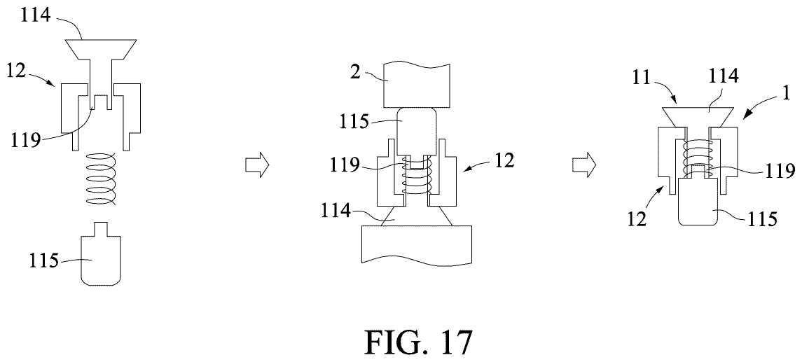

Referring to FIG. 17, as shown in the drawing, in a preferred embodiment of the present invention, the setting-up element 114 includes a rivet portion 119. The setting-up element 114 passes through the body 12 and is pressurized by a mold 2 to rivet the set-up element 115, so as to assemble the head 11 with the body 12, thereby quickly assembling into a control device 1 and achieving objects of easy assembly and better stability after the assembly.

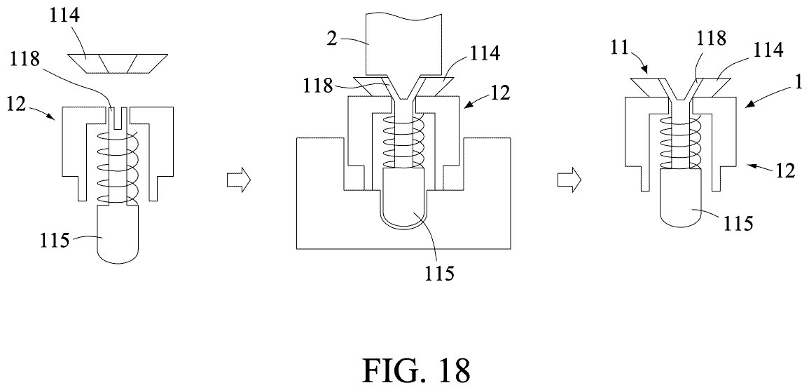

Referring to FIG. 18, as shown in the drawing, in a preferred embodiment of the present invention, the set-up element 115 includes an expansion connection portion 118. The set-up element 115 passes through the body 12 and is pressurized by a mold 2 to expandingly connect the expansion connection portion 118 to the setting-up element 114, so as to assemble the head 11 with the body 12, thereby quickly assembling into a control device 1 and achieving objects of easy assembly and better stability after the assembly.

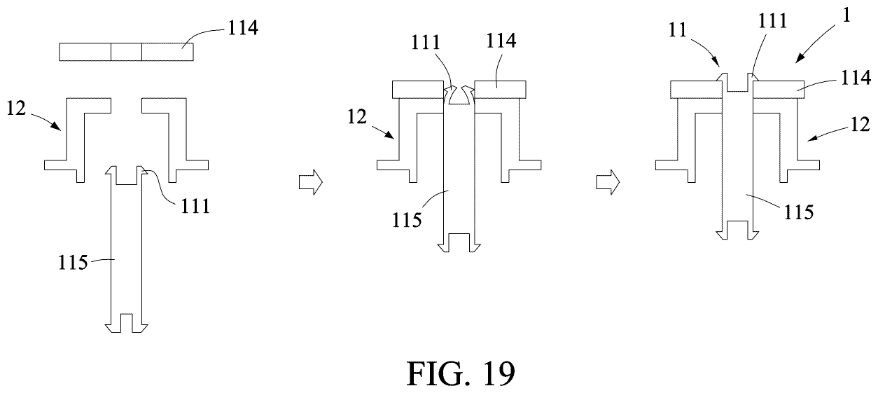

Referring to FIG. 19, as shown in the drawing, in a preferred embodiment of the present invention, the stopping portion 111 (or the corresponding stopping portion 121) can be an engaging portion, allowing the set-up element 115 to pass through the body 12 and to be elastically engaged with the setting-up element 114, so as to assemble the head 11 with the body 12, thereby quickly assembling into a control device 1 and achieving objects of easy assembly and better stability after the assembly.

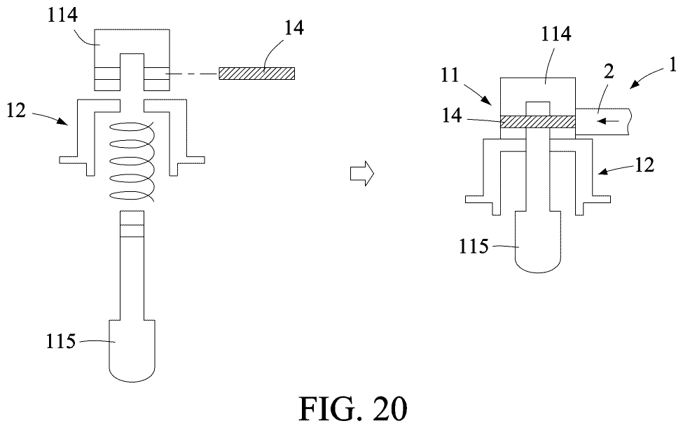

Referring to FIG. 20, as shown in the drawing, in a preferred embodiment of the present invention, the setting-up element 114 and the set-up element 115 are penetratingly connected by using a penetration connector 14 after being pressurized by a mold 2, so as to be movably assembled with the body 12 to further assemble the head 11 with the body 12, thereby quickly assembling into a control device 1 and achieving objects of easy assembly and better stability after the assembly.

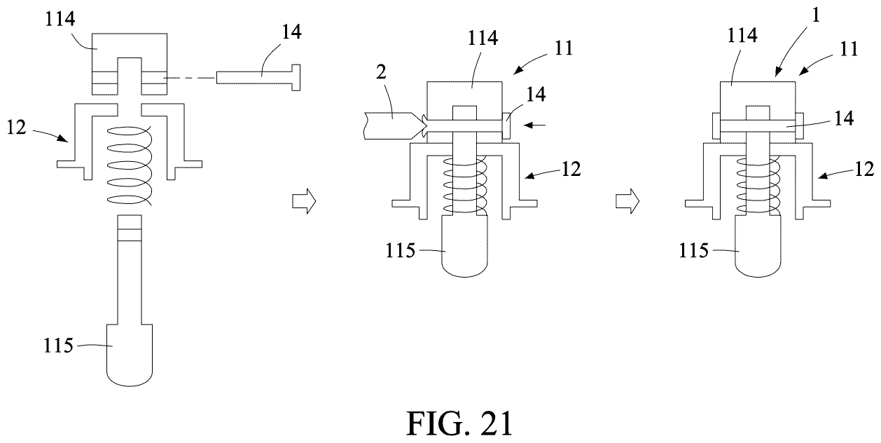

Referring to FIG. 21, as shown in the drawing, in a preferred embodiment of the present invention, the setting-up element 114 and the set-up element 115 are penetratingly connected by a penetration connector 14, and are expandingly connected by a mold 2, so as to be movably assembled with the body 12 to further assemble the head 11 with the body 12, thereby quickly assembling into a control device 1 and achieving objects of easy assembly and better stability after the assembly.

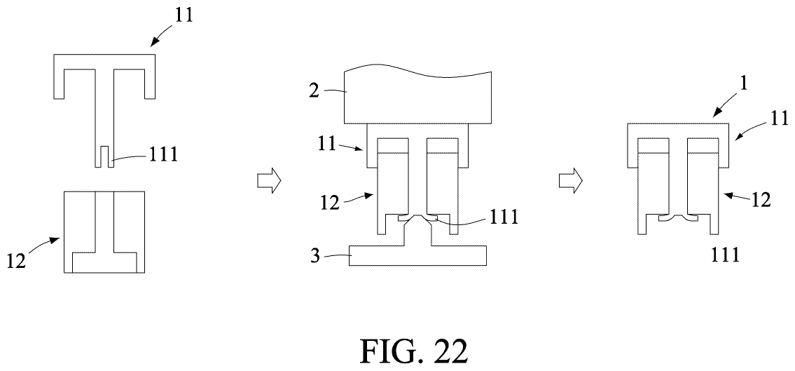

Referring to FIG. 22, as shown in the drawing, in a preferred embodiment of the present invention, the head 11 passes through the body 12 and the head 11 is then pressurized by a mold 2 to pressurize and deform by another mold 3 the stopping portion 111 that then protrudes outward, so as to assemble the head 11 with the body 12, thereby quickly assembling into a control device 1 and achieving objects of easy assembly and better stability after the assembly.

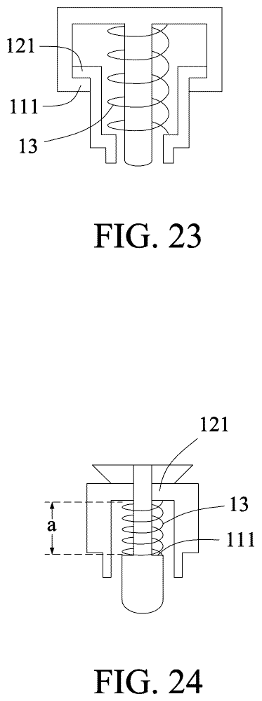

Referring to FIG. 23 and FIG. 24, as shown in the drawings, in a preferred embodiment of the present invention, the abutment of an elastic force of the elastic element 13 is interference abutment with a minimized distance (as shown in FIG. 23) or a spatial abutment with a maximized space a (as shown in FIG. 24) between the stopping portion 111 and the corresponding stopping portion 121, so as to respond to requirements of different utilization conditions.

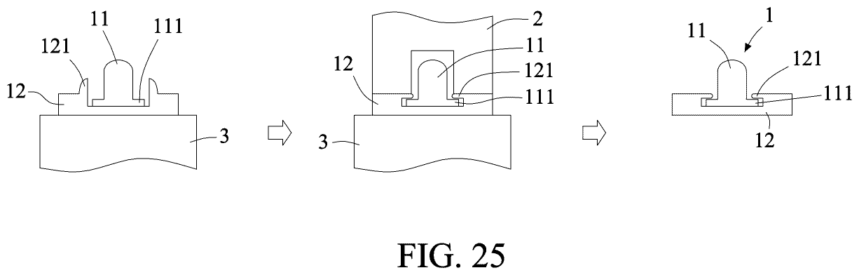

Referring to FIG. 25, as shown in the drawing, in a preferred embodiment of the present invention, the body 12 is placed on another mold 3, the head 11 is placed in the body 12, and the corresponding stopping portion 121 of the body 12 is pressurized by the mold 2 to deform the corresponding stopping portion 121 and to limit the stopping portion 111 of the head 11, so as to assemble the head 11 with the body 12, thereby quickly assembling into a control device 1 and achieving objects of easy assembly and better stability after the assembly.

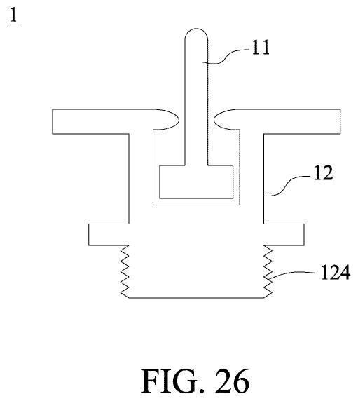

Referring to FIG. 26, as shown in the drawing, in a preferred embodiment of the present invention, the body 12 (or the head 11) of the control device 1 includes an engaging portion 124, and the engaging portion 124 is a threaded body, an outer engaging body, an elastic engaging body, an inner engaging body or a rod, so as to respond to requirements of different utilization conditions.

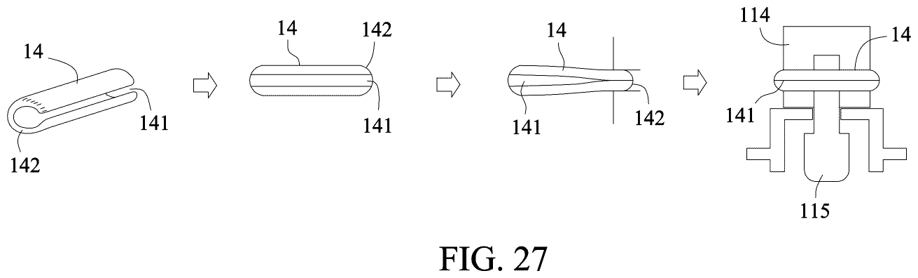

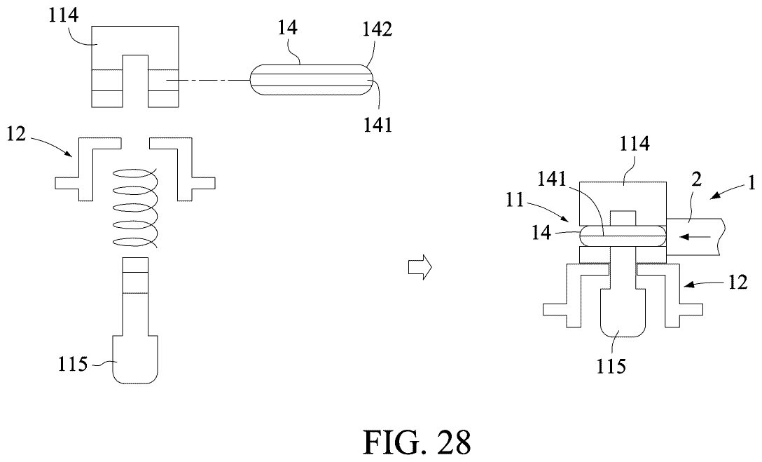

Referring to FIG. 27 and FIG. 28, as shown in the drawings, in a preferred embodiment of the present invention, the setting-up element 114 and the set-up element 115 are penetratingly connected and assembled by a penetration connector 14. The penetration connector 14 has an elastic engagement space 141, and the elastic engagement space 141 is pressed during the pressurizing and penetration connection for elastic abutment to assemble the setting-up element 114 with the set-up element 115.

The elastic engagement space 141 is located on one side of the penetration connector 14, at least one end of the penetration connector 14 includes a guiding entering portion 142, wherein the guiding entering portion 142 is an arc surface, a curved surface, an inclined surface or a stepped surface. The setting-up element 114 and the set-up element 115 are penetratingly connected by the penetration connector 14 so as to be movably assembled with the body 12. During the penetration connection, the penetration connector 14 penetrates into the setting-up element 114 and the set-up element 115 by using the guiding entering portion 142, and the setting-up element 114 is pressurized by the mold 2. The elastic engagement space 141 is pressed to elastically contract the penetration connector 14, so as to facilitate the penetration connection of the setting-up element 114 and the set-up element 115. Once the penetration connector 14 is assembled with the setting-up element 114 and the set-up element 115, the penetration connector 14 is expanded due to the elastic engagement space 141, allowing the penetration connector 14 to be abutted and assembled with the setting-up element 114 and the set-up element 115, enabling the head 11 to be movably assembled with the body 12 by expansion connection, thereby quickly assembling into a control device 1 and achieving objects of easy assembly and better stability after the assembly.

While the present invention has been disclosed by way of preferred embodiments above, it is to be understood by a person skilled in the art that, the embodiments are illustrative of the present invention and are not to be construed as limitations to the scope of the present invention. It should be noted that, equivalent modifications and substitutions made to the embodiments are to be encompassed within the scope of the present invention. Therefore, the legal protection of the present invention should be defined by the appended claims.

What is claimed is:

1. An assembly method of a control device, the control device comprising a head and a body, the head comprising a stopping portion, the body comprising a corresponding stopping portion; wherein, the head is assembled with the body after the head or the body is pressurized by an external force; wherein the head is pressurized by a mold to press the corresponding stopping portion of the body provided on another mold by the head and to form by deformation the corresponding stopping portion deformed inward, so as to stop and limit the stopping portion of the head.

2. The assembly method of a control device according to claim 1, further comprising an elastic element, wherein one end of the elastic element is abutted against the head and the other end of the elastic element is abutted against the body, abutment of an elastic force of the elastic element is interference abutment with a minimized distance or spatial abutment with a maximized space between the stopping portion and the corresponding stopping portion.

3. The assembly method of a control device according to claim 1, wherein the body comprises a coupling portion for rivet connecting, solder connecting, expansion connecting, lock connecting, elastic engagement connecting or engagement connecting to an object or forming an integral with an object.

4. The assembly method of a control device according to claim 1, wherein the head or the body comprises an engaging portion, and the engaging portion is a threaded body, an outer engaging body, an elastic engaging body, an inner engaging body or a rod.

5. The assembly method of a control device according to claim 1, wherein the head or the body is pressurized by a mold to press the corresponding stopping portion of the body provided on another mold and to form by deformation the corresponding stopping portion, so as to stop and limit the stopping portion.

6. A structure of a control device, manufactured by the method of claim 1.
